(19) United States
(12) Patent Application Publication
(10) Pub. No.: US 2026/0119114 A1
(43) Pub. Date: Apr. 30, 2026

(54) Audio Output Routing Via Screen Region

(71) Applicant: Dell Products L.P., Round Rock, TX (US)

(72) Inventors: Walter Kemp, Georgetown, TX (US); David Allen Dyson, Pflugerville, TX (US); Suraj M Varma, Portland, OR (US)

(73) Assignee: Dell Products L.P., Round Rock, TX (US)

(21) Appl. No.: 18/932,585

(22) Filed: Oct. 30, 2024

(51) Int. Cl. G06F 3/16

(52) U.S. Cl. CPC G06F 3/165; G06F 3/167

(57) ABSTRACT

This invention relates to an information handling system that enables audio output routing based on screen regions. The system comprises a display controller and an audio output controller, allowing users to associate specific audio playback devices with defined regions on a display. By determining the position of application windows, the system dynamically routes audio content to the appropriate playback device as the window moves between regions. This innovation supports seamless switching of audio outputs, enhancing user experience in environments requiring multiple audio configurations, such as audio mastering or multimedia applications.

### BACKGROUND

Desktop and laptop computers generate sounds through a combination of hardware and software components, enabling them to play sounds produced by applications. Applications such as music players, video games, or system notifications generate sound signals, which are typically in the form of digital audio data. This data is represented as a series of numbers that encode sound waves. The computer's operating system manages the applications' requests to play sounds, usually through an audio driver. The digital audio data is processed by the computer's sound card or other audio interface. This card converts the digital signals into analog signals that can be played by speakers or headphones. Many modern motherboards have integrated sound cards, while some high-performance systems use dedicated sound cards for better audio quality. At the core of the sound card is a Digital-to-Analog Converter (DAC) that transforms the digital signal (ones and zeros) into an analog signal (a continuous waveform). This process is necessary because speakers and headphones require analog signals to produce sound. The analog signal generated by the DAC is then sent to external or built-in speakers or headphones, where it vibrates a diaphragm to create sound waves. These sound waves are interpreted by the human ear as music, voice, or other audio.

### SUMMARY

According to one aspect, an Information Handling System (IHS) for providing audio routing based on screen location comprises at least one processor configured to execute an operating system (OS) and one or more applications. The OS comprises a display controller configured to manage visual content presented on a display, wherein the visual content is generated from the one or more applications, and an audio output controller configured to manage audio content provided to one or more audio playback devices. The OS is configured to identify two or more display regions on the display, determine a screen location of an application window presented on the display, wherein the application window contains visual content associated with an application, and automatically route audio content associated with the application based upon the screen location of the application window relative to the two or more display regions.

The audio content may be automatically routed to an audio playback device associated with a screen region in which the application window is displayed.

The audio playback device may be selected from one or more of: an internal speaker, an external speaker, a soundbar, a subwoofer, a center-channel speaker, a passive speaker, and an active speaker.

The audio content may be automatically routed to an audio mixer or an audio signal processing application associated with a screen region in which the application window is displayed.

The screen location of the application window may be determined based upon one of: a center point of the application window, a corner of the application window, and an edge of the application window.

The screen location of the application window relative to the two or more display regions may be determined based upon which of the two or more display regions contains the highest percentage of the application window.

The OS may be further configured to automatically reroute audio content associated with the application based upon a change in screen location of the application window from a display region to a second display region.

The audio content may be automatically routed to an audio playback device associated with a screen region in which the application window is displayed, and the audio content is automatically routed to an audio mixer or an audio signal processing application associated with the screen region in which the application window is displayed.

In another example configuration, a method for routing audio content in an Information Handling System (IHS) comprises identifying a location of a first application window on an IHS display, wherein the first application window is associated with a first application hosted by the IHS, identifying a display screen region associated with the location of the first application window, and automatically routing, by an IHS operating system, audio content associated with the first application based upon the identified display screen region.

The method may further comprise receiving user input to identify two or more display screen regions on the IHS display, and receiving user input to identify an audio playback device associated with each of the two or more display screen regions.

The method may further comprise receiving user input to identify two or more display screen regions on the IHS display, and receiving user input to identify an audio mixer or an audio signal processing application associated with each of the two or more display screen regions.

The audio content may be automatically routed to an audio playback device associated with the display screen region in which the application window is displayed.

The audio playback device may be selected from one or more of: an internal speaker, an external speaker, a soundbar, a subwoofer, a center-channel speaker, a passive speaker, and an active speaker.

The audio content may be automatically routed to an audio mixer or an audio signal processing application associated with the display screen region in which the application window is displayed.

The screen location of the first application window may be identified based upon one of: a center point of the first application window, a corner of the first application window, and an edge of the first application window.

The screen location of the first application window relative to the two or more display regions may be determined based upon which of the two or more display regions contains the highest percentage of the first application window.

The OS may be further configured to automatically reroute audio content associated with the application based upon a change in location of the application window from a first display screen region to a second display screen region.

The audio content may be automatically routed to an audio playback device associated with the display screen region in which the application window is displayed, and the audio content is automatically routed to an audio mixer or an audio signal processing application associated with the display screen region in which the application window is displayed.

According to yet another aspect, the method further comprises identifying a location of a second application window on the IHS display, wherein the second application window is associated with a second application hosted by the IHS, identifying a display screen region associated with the location of the second application window, and automatically routing, by an IHS operating system, audio content associated with the second application based upon the identified display screen region, wherein routing of the audio content associated with the second application is different from routing audio content associated with the second application.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating an embodiment of an information handling system according to an example embodiment.

FIG. 2 illustrates an example embodiment of a workstation having multiple monitors that may be used to display applications that generate audio content.

FIG. 3 illustrates an example workstation configuration in which an information handling system generates different audio outputs based upon different positions on display screen.

FIG. 4 illustrates an example system for configurating display regions on a monitor wherein the display regions are associated with different audio playback devices, audio mixers, or audio processing applications.

FIG. 5 illustrates one system for selecting audio playback devices that should be associated with each display region.

FIG. 6 is a block diagram illustrating components of a system for providing different audio output routing for different screen regions.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

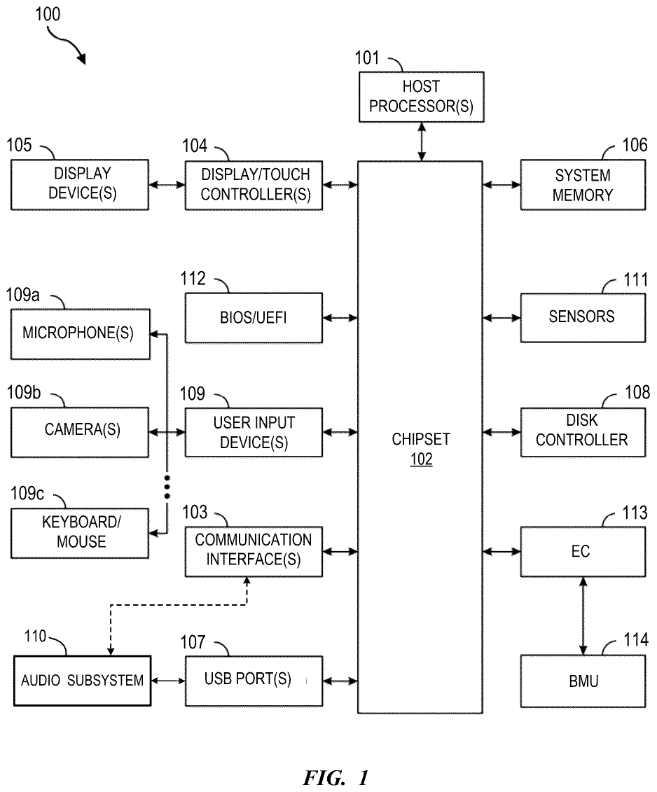

FIG. 1 is a block diagram illustrating an embodiment of an IHS 100. As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to resources. In some cases, chipset 102 may utilize a QuickPath Interconnect (QPI) bus to communicate with host processor(s) 101. Chipset 102 may also be coupled to communication interface(s) 103 to enable communications between IHS 100 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 103 may be used to communicate with peripheral devices (e.g., Bluetooth speakers, microphones, headsets, etc.). Moreover, communication interface(s) 103 may be coupled to chipset 102 via a Peripheral Component Interconnect Express (PCIe) bus, or the like.

Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 provide video or display signals to one or more display device(s) 105. Display device(s) 105 may include Liquid Crystal Display (LCD), Light Emitting Diode (LED), Organic LED (OLED), or other thin film display technologies. Display device(s) 105 may include a plurality of pixels arranged in a matrix, configured to display visual information, such as text, two-dimensional images, video, three-dimensional images, etc. In some cases, display device(s) 105 may be provided as a single continuous display, rather than two discrete displays.

Chipset 102 may provide host processor(s) 101 and/or display controller(s) 104 with access to system memory 106. In various embodiments, system memory 106 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more Universal Serial Bus (USB) ports/controllers 107, to which one or more peripheral devices may be coupled (e.g., integrated or external webcams, microphones, speakers, etc.).

Chipset 102 may further provide host processor(s) 101 with access to a disk controller 108, which may include a disk interface that connects the disc controller 108 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 100. An example of external interface includes a USB interface, an IEEE 1394 (Firewire) interface, a proprietary interface, or a combination thereof.

Chipset 102 may also provide access to one or more user input devices 109, for example, using a super I/O controller or the like. Examples of user input devices 109 include, but are not limited to, microphone(s) 109a, camera(s) 109b, and/or keyboard/mouse 109c. Other user input devices 109 (not shown) may include a touchpad, stylus or active pen, totem, etc. Each user input device 109 may include a respective controller (e.g., a touchpad may have its own touchpad controller) that interfaces with chipset 102 through a wired or wireless connection, for example via communication interfaces(s) 103 and/or USB port(s) 107.

In some cases, chipset 102 may also provide access to one or more output devices, such as an audio subsystem 110, speakers, headsets, video projectors, paper printers, 3D printers, Virtual/Augmented Reality (VR/AR) devices, etc. The output devices may be accessed, for example, via communication interfaces(s) 103 and/or USB port(s) 107

In certain embodiments, chipset 102 may further provide an interface for communications with one or more hardware sensors 111. Sensors 111 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 112 is coupled to chipset 102. UEFI was designed as a successor to BIOS, and many modern IHSs utilize UEFI in addition to or instead of a BIOS. Accordingly, BIOS/UEFI 112 is intended to also encompass a UEFI component. BIOS/UEFI 112 provides an abstraction layer that allows the OS to interface with certain hardware components that are utilized by IHS 100. Upon booting of IHS 100, host processor(s) 101 may utilize program instructions of BIOS 112 to initialize and test hardware components coupled to IHS 100, and to load a host OS for use by IHS 100. Via the hardware abstraction layer provided by BIOS/UEFI 112, software stored in system memory 106 and executed by host processor(s) 101 can interface with I/O devices coupled to IHS 100.

An Embedded Controller (EC) 113 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 100, EC 113 may be made operational from the very start of each power reset, before other devices are fully running or powered on. As such, EC 113 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 113 may be used to manage other core operations of IHS 100 (e.g., turbo modes, maximum operating clock frequencies of certain components, etc.).

In some cases, EC 113 may implement operations for detecting certain changes to the physical configuration or posture of IHS 100 and managing other devices in different configurations of IHS 100. For instance, when IHS 100 as a 2-in-1 laptop/tablet form factor, EC 113 may receive inputs from a lid position or hinge angle sensor 111, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

In some implementations, EC 113 may be installed as a Trusted Execution Environment (TEE) component to the motherboard of IHS 100. Additionally, or alternatively, EC 113 may be further configured to calculate hashes or signatures that uniquely identify individual components of IHS 100. In such scenarios, EC 113 may calculate a hash value based on the configuration of a hardware and/or software component coupled to IHS 100. For instance, EC 113 may calculate a hash value based on all firmware and other code or settings stored in an onboard memory of a hardware component.

In addition, EC 113 may provide an Out-of-Band communication channel that allows an Information Technology Decision Maker (ITDM) or Original Equipment Manufacturer (OEM) to manage IHS 100's various settings and configurations, for example, by issuing OOB commands.

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries).

Battery Management Unit (BMU) 114 may be coupled to EC 113 and it may include, for example, an Analog Front End (AFE), storage (e.g., non-volatile memory), and a microcontroller. In some cases, BMU 114 may be configured to collect and store information, and to provide that information to other IHS components.

Examples of information collectible by BMU 114 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 100 may not include all the components shown in FIG. 1. Furthermore, some components that are represented as separate components in FIG. 1 may instead be integrated with other components, such that all or a portion of the operations executed by the illustrated components may instead be executed by the integrated component.

For example, in various embodiments described herein, host processor(s) 101 and/or other components shown in FIG. 1 (e.g., chipset 102, display controller(s) 104, communication interface(s) 103, EC 113, etc.) may be replaced by other devices. As such, IHS 100 may assume different form factors including, but not limited to: servers, workstations, desktops, laptops, appliances, video game consoles, tablet computers, smartphones, etc.

In current systems, audio output is determined by the mixer settings of the operating system, which does not include the ability to specify multiple audio outputs. Existing operating systems do not provide a means to associate audio from different applications to different output devices. Some uses, such as for audio mastering, require listening to the same audio though multiple speakers and/or audio systems. For example, a user may want some audio to go to headphones while other audio goes to speakers.

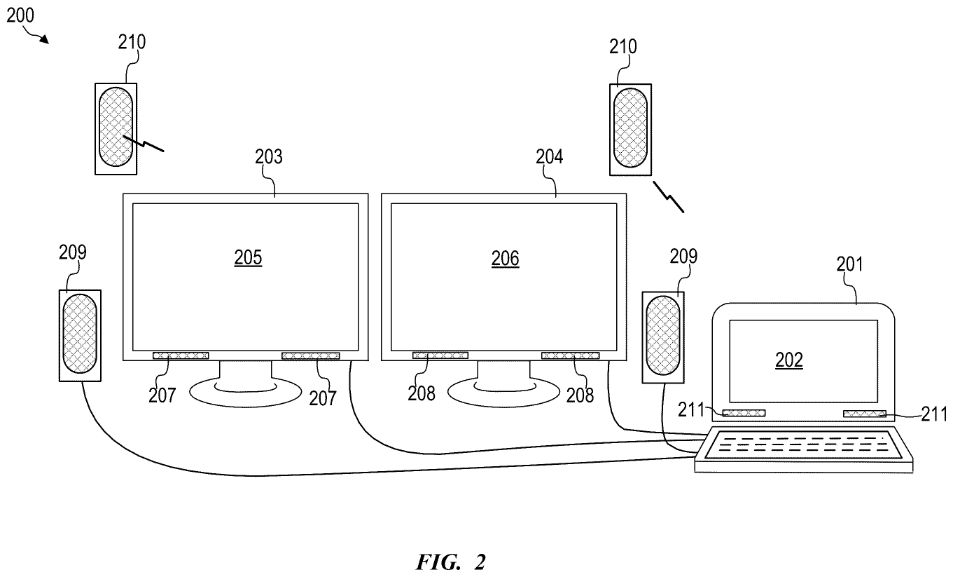

FIG. 2 illustrates an example embodiment of a workstation 200 having multiple monitors that may be used to display applications that generate audio content. An IHS 201, such as a laptop computer, has an architecture such as the embodiment shown in FIG. 1. IHS 201 may alternatively be a desktop computer, tablet computer, game console, or other device that supports multiple monitors. In the illustrated embodiment, laptop IHS 201 has a display screen 202 that is used to display applications and other content. IHS 201 is coupled to two external monitors 203, 204 having displays 205, 206, respectively. User interfaces and other visual content generated by applications running on IHS 201 may also be displayed on either or both external monitors 203, 204. Each monitor 203, 204 may have one or more speakers 207, 208, respectively. The monitors 203, 204 are connected to IHS 201 via a wired or wireless connection (e.g., HDMI cable, audio cable, Bluetooth connection, etc.) that allows audio content from applications running on IHS 201 to be played over speakers 203 and/or 204.

IHS 201 is also connected to a first pair of external speakers 209 and a second pair of external speakers 210. Speakers 209, 210 may be connected to IHS 201 a wired or wireless connection (e.g., audio cable, Bluetooth connection, etc.). Additionally, IHS 201 may have internal speakers 211.

Devices, such as IHS 201, using existing Operating Systems (OS), such as Windows 10, macOS, or Linux OS, determine which speakers to use based on a selected audio output device configuration. This may include a default output device wherein the OS assigns a default audio output device, such as built-in speakers, external speakers, headphones, Bluetooth devices, etc.), on which sounds are played. A user may manually select the preferred audio device in the OS sound settings. In some cases, built-in detection systems either in IHS hardware or the OS may prioritize external audio devices, such as speakers using an audio jack or a Bluetooth/USB connection. Audio drivers, such as software that interfaces between the OS and audio hardware, may also manage which speakers are used. Using currently available sound settings, IHS 201 selects only one set of speakers, 207, 208, 209, 210, or 211 to play audio content. Audio signals are routed directly to audio subsystem 110 for presentation by the selected speakers only. To use a different set of speakers in current systems, the user must select a new default speaker in the OS audio or sound settings.

In existing systems, the user interface window for applications running on IHS 201 may be presented on any of displays 202, 205, 206 and/or may be positioned so that they overlap multiple displays. Current OS audio management does not provide any positional properties based on application display. Instead, no matter which display is being used for an application, the sounds associated with that application will be broadcast over an output speaker selected for a current configuration.

Embodiments disclosed herein provide systems and methods in which different regions on display screen can be designated for different audio outputs. This allows a user to place an application window in a designated display region associated with a desired audio playback device or configuration, such as a particular audio mixing selection. The audio playback or output device may be different based upon placement on different regions of the display screen. The user may quickly change the output used by a particular application by simply moving the application to a different screen region or monitor. This configuration supports the creation of “virtual” input and output devices so that audio can be sent from one display region to another similar to creating an internal audio bus.

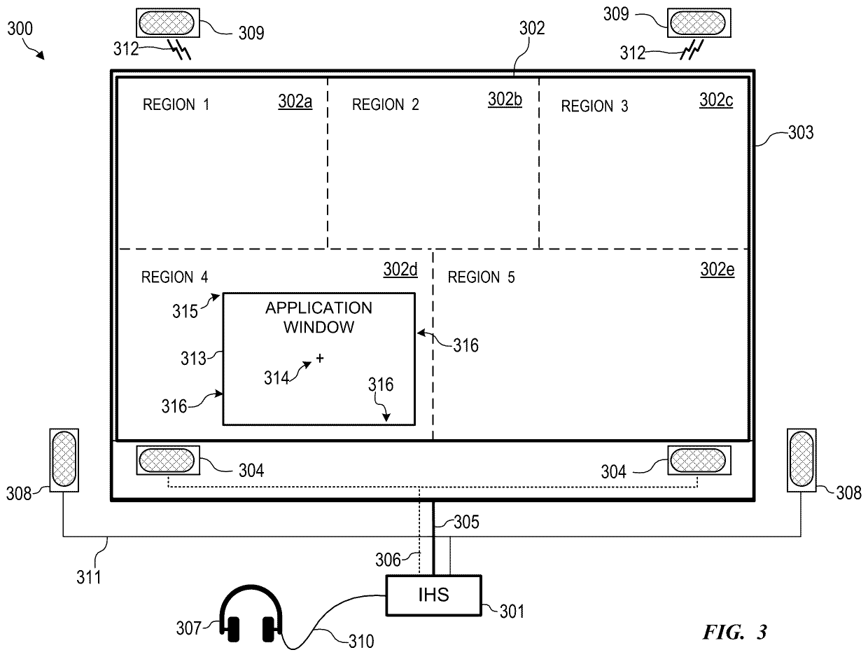

FIG. 3 illustrates an example workstation configuration 300 in which an IHS 301 generates different audio outputs based upon different positions on display screen 302. A typical workstation monitor 303 includes a display 302 and internal speakers 304. IHS 301 provides video content to monitor 303 via an HDMI cable 305, for example. Audio content to be played back on speakers 304 may be carried by the HDMI cable 305 or by a separate audio cable 306. IHS 301 may also be connected to additional audio playback devices, such as headphones 307, external speakers 308, or wireless speakers 309. Headphones 307 may be wirelessly connected to IHS 301 using, for example, a Bluetooth connection or may be connected via a wired connection, such as using an audio or USB cable 310. As illustrated in FIG. 3, external speakers 308 are connected to IHS 301 by an audio or USB cable 311. External speakers 309 are connected to IHS 301 via a wireless connection 312, such as a radio frequency connection over a Bluetooth or WiFi network. While only two speakers are illustrated for external wired and wireless speaker groups 308, 309, it will be understood that additional speakers of various types may be included with various speaker groups, such as, for example, floor speakers, bookshelf speakers, soundbars, subwoofers, center-channel speakers, passive speakers, active speakers, etc.

The display area 302 on monitor 303 has been divided into five different regions 302a-e. Each region 302a-e may be associated with a different audio output. For example, each region 30a-e may be associated with a different audio playback system, such as monitor speakers 304, headphones 307, external speakers 308, or Bluetooth speakers 309. Alternatively, and/or additionally, each region 30a-e may be associated with different audio effects, such as time-based audio effects (e.g., reverb, delay, and echo), modulation audio effects (e.g., chorus, tremolo, flanger, and phaser), spectral audio effects (e.g., panning and equalization), dynamic audio effects (e.g., compression and distortion) and filters (e.g., low-pass filter, band-pass filter, high-pass filter).

IHS 301 generates the display content for monitor 303 based upon various applications executing on the IHS. For example, IHS 301 may run productivity applications (e.g., word processing, spreadsheets, presentation software, and project management tools), web browsers, communication and collaboration tools (e.g., email clients, video conferencing, and messaging platforms), media and entertainment applications, development and coding tools, gaming applications, or other applications used in professional, personal, and entertainment contexts on laptops. These applications may also generate audio content, such as user audio from a video conference, movie dialog and/or music in an entertainment application, and tones generated by OS system alerts and error/warning popups.

Each of the applications may have a user interface, such as an application window 313, that displays information associated with the application and allows the user to interact with the application. A user of IHS 301 may position application window 313 anywhere on display 302, which includes positioning the application window 313 within one of the regions 302a-e. When an application window 313 is placed (e.g., drag and dropped) within a selected display region 302a-e, the audio content associated with application window 313 will be presented using the audio playback devices and/or audio mixing/processing designated for the selected region 302a-e. The audio content corresponds to audio generated by the application underlying the application window 313, such as a music or movie streaming application, a video conference application, an audio editing application, etc. This allows for multiple audio output devices to be used by the system and further allows the user to pick an output device based on display location.

In an example configuration for workstation 300, a user is working on an audio application, such as a music editing application, that is shown in application window 313. The user may set the audio output for each region as
Region 1 (302a)—Monitor Speakers (304)
Region 2 (302b)—Bluetooth Speakers (309)
Region 3 (302c)—USB External Speakers (308)
Region 4 (302d)—Headphones (307)
Region 5 (303e)—Monitor Speakers (304)

The user working on the audio application can play and/or replay audio from the application through different audio playback configurations, such speaker types and/or different audio mixing/processing. The user simply has to move the application window 313 from one region to another to quickly change the audio playback configuration. With the example configuration shown in FIG. 3, the user has up to five different audio playback configurations available. This allows the user to play an audio project (e.g., music being edited) over five different outputs (e.g., five different speaker systems) simply by dragging the application to different regions 302a-e on display 302. With the application window 313 in region 302d as illustrated, the audio would be played via headphones 307. The user can drag application window 313 to region 302b to instead hear the audio via Bluetooth speakers 309. The user can quickly evaluate a number of different speaker configurations and/or evaluate how an audio track sounds with different audio mixing configurations using this system.

When the application window is overlapping multiple regions 302a-e, the IHS may use some feature of the application window 313 to determine which region 302a-e should be selected for the application window 313. For example, the IHS may use the location of the window's center point 314, a corner 315 of the window, or any edge 316 of the window as a reference point for the window's location. Alternatively, the IHS may determine which region 302a-e contains the highest percentage of the application window's area and then use that region to select the audio playback configuration.

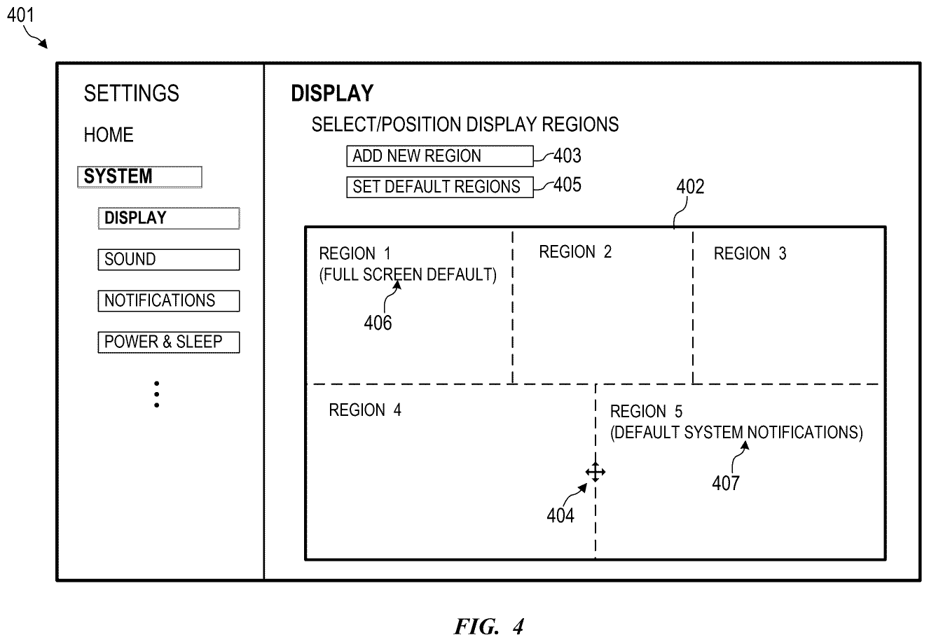

FIG. 4 illustrates one system for configurating display regions, such as display regions 302a-e on monitor 303 (FIG. 3). An example system settings menu 401 allows a user to configure operating parameters for an IHS, such as display, sound, notification, and power settings. A system display configuration menu is shown in FIG. 4. An example screen layout 402 is displayed for the user. Initially, the example screen layout 402 may show a single, full-screen region. The user may select an “add new region” option 403 to begin dividing the screen layout 402 into multiple regions. The screen layout 402 corresponds to the display on a monitor connected to the IHS, such as display area 302 on monitor 303 (FIG. 3). In other embodiments, where multiple displays are connected to an IHS, menu 401 may show a screen layout for each monitor and each monitor may be divided into multiple audio playback regions.

The user may configure the size and location of each region using a mouse or other pointing device. The user moves the mouse cursor over the boundary between two regions, such as a boundary between regions 4 and 5 as illustrated in FIG. 4. Once the cursor is over the boundary, the cursor 404 changes to a black bar with two arrows pointing in opposite directions. The user then just clicks the mouse and drags the boundary to adjust the size. This allows the user to quickly adjust the height and/or width of each region.

The user may also have the option to set default regions 405. The default setting may address issues such as what region's audio settings apply when an application is maximized to full-screen size. When the application window is shown as a full-screen, the window will cover all of the regions. The user may select one of the regions settings as a default for such full-screen displays. In the illustrated example, the audio playback configuration for region 1 is selected as a default audio mode 406 for full-screen applications. In other configurations, the user may select a default audio configuration for system notifications. This can be used to ensure that system alerts are not distorted or otherwise blocked from the user when multiple audio playback modes are available. In the illustrated example, region 5 is selected for the default audio mode 407 for system notifications.

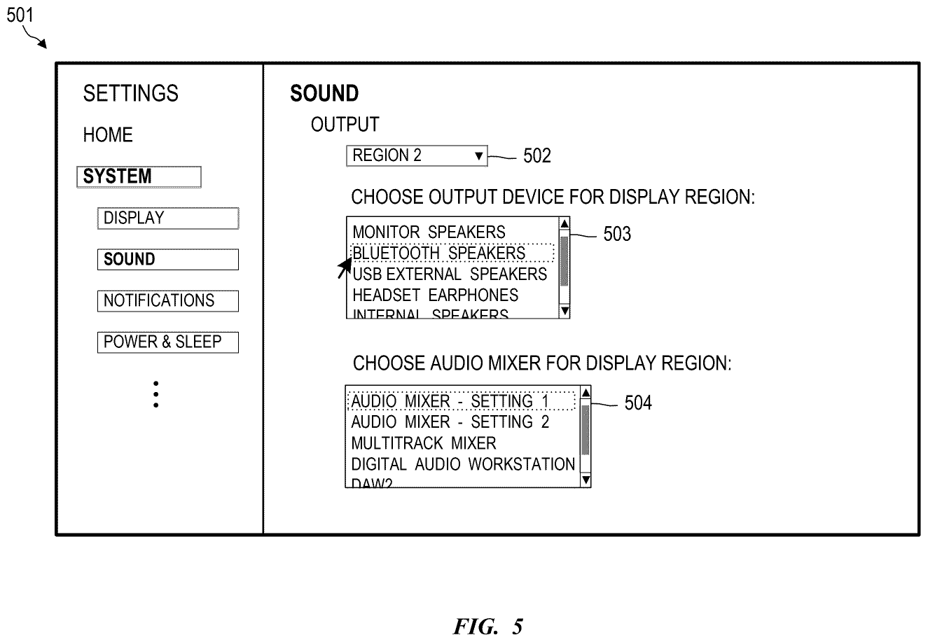

FIG. 5 illustrates one system for selecting audio playback devices that should be associated with each display region. An example system settings menu 501 allows a user to configure operating parameters for an IHS, such as display, sound, notification, and power settings. A system display configuration menu is shown in FIG. 5. A list of display regions is available to the user, such as via a dropdown menu 502. In one embodiment, as the user creates or configures regions on the display screen, the sound settings include each region for configuration. After selecting a screen region 502, the user is presented with a list of audio playback devices 503 from which a desired output audio can be designated for the selected region 502. In the illustrated menu, display region 2 is being configured, and the user may select Bluetooth speakers as an output consistent with the example above. The user may select a different audio playback option 503 for each screen region 502 or may elect to have some regions use the same output device. In addition to listing available screen regions 502, menu 501 may also provide options to select the audio playback for full screen applications, such as when an application window is maximized to fill the display. Other default options may also be included, such as audio playback preferences for additional monitors.

The sound settings menu 501 may also provide options for different mixers or other audio processing applications 504. For each display region 502, the user may also select a particular mixer or other audio processing that should be applied to the audio content. For example, the IHS may have multiple audio signal mixer applications. The user may select a different mixer applications for each designated screen region. Alternatively, the user may configure multiple settings for one mixer application and then designated different settings to apply in different screen regions. For example, the audio mixer application may be set to use a reverb effect in one setting and to use an echo effect in another setting. Each of these settings may be assigned to two different screen regions. The operating system will use the same mixer application in both screen regions but will apply the appropriate setting for the region to create a different audio effect.

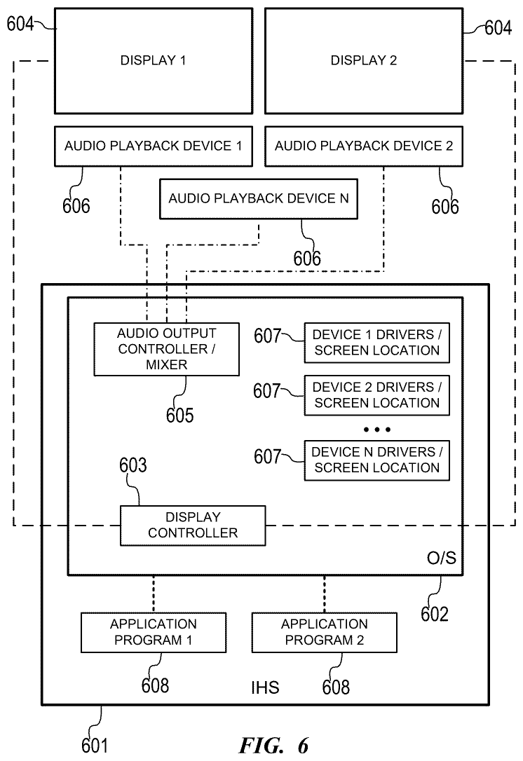

FIG. 6 is a block diagram illustrating components of a system for providing different audio output routing for different screen regions. IHS 601 has an operating system (OS) 602. A display controller module 603 in OS 602 is responsible for managing display content for one or more displays 604. An audio output controller/mixer 605 in OS 602 is responsible for managing audio content to be played on one or more audio playback devices 606. The audio playback devices 606 may be associated with a particular display 604 or may be an independent device, such as an external speaker, sound bar, headphones, etc.

The OS 602 maintains information regarding audio device drivers and location 607, which is associated with each of the audio playback devices 606. The audio device drivers and location 607 information may include, for example, the identity of a driver that should be loaded to use a particular audio playback devices 606, and the relative screen locations associated with the audio playback devices 606. The location may identify a screen region on the displays 604 that has been associated with each audio playback device 606.

IHS 601 executes one or more application programs 608, such as productivity applications (e.g., word processing, spreadsheets, presentation software, and project management tools), web browsers, communication and collaboration tools (e.g., email clients, video conferencing, and messaging platforms), media and entertainment applications, development and coding tools, gaming applications, or other personal or professional applications. The application programs 608 generate display and audio content to be presented to users. The application programs 608 coordinate with OS 602 to provide the display and audio content to displays 604 and audio playback devices 606.

Using the device driver and location information 607, the audio output controller/mixer 605 is capable of controlling multiple audio playback devices at the same time—unlike current systems in which the OS only controls one audio playback device at a time. Additionally, OS 602 is aware of how the display content for a particular application program is displayed (i.e., screen location and size) on displays 604. Using the location of the display content, audio output controller/mixer 605 can manage the associated audio content and provide the audio signal to the appropriate audio playback device for a particular screen region.

In an example configuration, an Information Handling System (IHS) for providing audio routing based on screen location comprises at least one processor configured to execute an operating system (OS) and one or more applications. The OS comprising a display controller configured to manage visual content presented on a display, wherein the visual content is generated from the one or more applications; and an audio output controller configured to manage audio content provided to one or more audio playback devices. The OS is configured to identify two or more display regions on the display; determine a screen location of an application window presented the display, wherein the application window contains visual content associated with an application; and automatically route audio content associated with the application based upon the screen location of the application window relative to the two or more display regions.

The audio content is automatically routed to an audio playback device associated with a screen region in which the application window is displayed. The audio playback device is selected from one or more of: an internal speaker, an external speaker, a soundbar, a subwoofer, a center-channel speaker, a passive speaker, and an active speaker.

The audio content is automatically routed to an audio mixer or an audio signal processing application associated with a screen region in which the application window is displayed.

The screen location of the application window is determined based upon one of: a center point of the application window, a corner of the application window, and an edge of the application window.

The screen location of the application window relative to the two or more display regions is determined based upon which of the two or more display regions contains the highest percentage of the application window.

The OS is further configured to automatically reroute audio content associated with the application based upon a change in screen location of the application window from a display region to a second display region.

The audio content is automatically routed to an audio playback device associated with a screen region in which the application window is displayed, and wherein the audio content is automatically routed to an audio mixer or an audio signal processing application associated with the screen region in which the application window is displayed.

In another example configuration, a method for routing audio content in an Information Handling System (IHS) comprises identifying a location of a first application window on an IHS display, wherein the first application window is associated with a first application hosted by the IHS; identifying a display screen region associated with the location of the first application window; and automatically routing, by an IHS operating system, audio content associated with the first application based upon the identified display screen region.

The method further comprises receiving user input to identify two or more display screen regions on the IHS display; and receiving user input to identify an audio playback device associated with each of the two or more display screen regions.

The method further comprises receiving user input to identify two or more display screen regions on the IHS display; and receiving user input to identify an audio mixer or an audio signal processing application associated with each of the two or more display screen regions.

The audio content is automatically routed to an audio playback device associated with the display screen region in which the application window is displayed.

The audio playback device is selected from one or more of: an internal speaker, an external speaker, a soundbar, a subwoofer, a center-channel speaker, a passive speaker, and an active speaker.

The audio content is automatically routed to an audio mixer or an audio signal processing application associated with the display screen region in which the application window is displayed.

The screen location of the first application window is identified based upon one of: a center point of the first application window, a corner of the first application window, and an edge of the first application window.

The screen location of the first application window relative to the two or more display regions is determined based upon which of the two or more display regions contains the highest percentage of the first application window.

The OS is further configured to automatically reroute audio content associated with the application based upon a change in location of the application window from a first display screen region to a second display screen region.

The audio content is automatically routed to an audio playback device associated with the display screen region in which the application window is displayed, and wherein the audio content is automatically routed to an audio mixer or an audio signal processing application associated with the display screen region in which the application window is displayed.

The method further comprises identifying a location of a second application window on the IHS display, wherein the second application window is associated with a second application hosted by the IHS; identifying a display screen region associated with the location of the second application window; and automatically routing, by an IHS operating system, audio content associated with the second application based upon the identified display screen region, wherein routing of the audio content associated with the second application is different from routing audio content associated with the second application.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. An Information Handling System (IHS) for providing audio routing based on screen location, comprising:
at least one processor configured to execute an operating system (OS) and one or more applications, the OS comprising:
a display controller configured to manage visual content presented on a display, wherein the visual content is generated from the one or more applications; and
an audio output controller configured to manage audio content provided to one or more audio playback devices;
wherein the OS is configured to:
identify two or more display regions on the display;
determine a screen location of an application window presented the display, wherein the application window contains visual content associated with an application; and
automatically route audio content associated with the application based upon the screen location of the application window relative to the two or more display regions.

2. The IHS of claim 1, wherein the audio content is automatically routed to an audio playback device associated with a screen region in which the application window is displayed.

3. The IHS of claim 2, wherein the audio playback device is selected from one or more of: an internal speaker, an external speaker, a soundbar, a subwoofer, a center-channel speaker, a passive speaker, and an active speaker.

4. The IHS of claim 1, wherein the audio content is automatically routed to an audio mixer or an audio signal processing application associated with a screen region in which the application window is displayed.

5. The IHS of claim 1, wherein the screen location of the application window is determined based upon one of: a center point of the application window, a corner of the application window, and an edge of the application window.

6. The IHS of claim 1, wherein the screen location of the application window relative to the two or more display regions is determined based upon which of the two or more display regions contains the highest percentage of the application window.

7. The IHS of claim 1, wherein the OS is further configured to:
automatically reroute audio content associated with the application based upon a change in screen location of the application window from a display region to a second display region.

8. The IHS of claim 1, wherein the audio content is automatically routed to an audio playback device associated with a screen region in which the application window is displayed, and wherein the audio content is automatically routed to an audio mixer or an audio signal processing application associated with the screen region in which the application window is displayed.

9. A method for routing audio content in an Information Handling System (IHS), comprising:
identifying a location of a first application window on an IHS display, wherein the first application window is associated with a first application hosted by the IHS;
identifying a display screen region associated with the location of the first application window; and
automatically routing, by an IHS operating system, audio content associated with the first application based upon the identified display screen region.

10. The method of claim 9, further comprising:
receiving user input to identify two or more display screen regions on the IHS display; and
receiving user input to identify an audio playback device associated with each of the two or more display screen regions.

11. The method of claim 9, further comprising:
receiving user input to identify two or more display screen regions on the IHS display; and
receiving user input to identify an audio mixer or an audio signal processing application associated with each of the two or more display screen regions.

12. The method of claim 9, wherein the audio content is automatically routed to an audio playback device associated with the display screen region in which the application window is displayed.

13. The method of claim 12, wherein the audio playback device is selected from one or more of: an internal speaker, an external speaker, a soundbar, a subwoofer, a center-channel speaker, a passive speaker, and an active speaker.

14. The method of claim 9, wherein the audio content is automatically routed to an audio mixer or an audio signal processing application associated with the display screen region in which the application window is displayed.

15. The method of claim 9, wherein the screen location of the first application window is identified based upon one of: a center point of the first application window, a corner of the first application window, and an edge of the first application window.

16. The method of claim 9, wherein the screen location of the first application window relative to the two or more display regions is determined based upon which of the two or more display regions contains the highest percentage of the first application window.

17. The method of claim 9, wherein the OS is further configured to:
automatically reroute audio content associated with the application based upon a change in location of the application window from a first display screen region to a second display screen region.

18. The method of claim 9, wherein the audio content is automatically routed to an audio playback device associated with the display screen region in which the application window is displayed, and wherein the audio content is automatically routed to an audio mixer or an audio signal processing application associated with the display screen region in which the application window is displayed.

19. The method of claim 9, further comprising:
identifying a location of a second application window on the IHS display, wherein the second application window is associated with a second application hosted by the IHS;
identifying a display screen region associated with the location of the second application window; and
automatically routing, by an IHS operating system, audio content associated with the second application based upon the identified display screen region, wherein routing of the audio content associated with the second application is different from routing audio content associated with the second application.
